(19) United States
(12) Patent Application Publication
(10) Pub. No.: US 2009/0078095 A1
(43) Pub. Date: Mar. 26, 2009

(54) SCREWDRIVER MADE BY NON-CONDUCTIVE MATERIAL

(76) Inventor: Chih-Ching Hsieh, Fengyuan City (TW)

Correspondence Address: PHILLIP LIU, 6980, WHITEOAK DR., RICHMOND, BC, V7EAZ9, CA

(21) Appl. No.: 11/902,541

(22) Filed: Sep. 24, 2007

(51) Int. Cl. B25G 1/12

(52) U.S. Cl. 81/436

(57) ABSTRACT

A screwdriver includes a handle and a shank has one end integrally connected to the handle, a function end is connected to the other end of the shank. The handle and the shank are made by Polyphenylene Sulfide (PPS), Polytetrafluoroethylene (PTFE) or Polyetheretherketones (PEEK), the function end is made by Polyoxymethylene (POM). The screwdriver is light and non-conductive.

### FIELD OF THE INVENTION

The present invention relates to a screwdriver made by non-conductive material such as Polyphenylene Sulfide (PPS), Polytetrafluoroethylene (PTFE) or Polyetheretherketones (PEEK).

### BACKGROUND OF THE INVENTION

A conventional screwdriver generally includes a handle and a shank has one end fixed to the handle and the other end of the shank is formed with a function end such as a keystone tip, cabinet tip or Phillips head tip so as to be engaged with different types of screws. Some screwdrivers are cooperated with a driving mechanism to be power tools which are operated by a motor powered by AC or DC current. The user holds the handle and rotates the screwdriver to tighten or loosen the screws. In order to securely connect the function end of the shank with the screws to be tightened or loosened, some users holds the handle by one hand and the shank by the other hand so as to position the shank at correction position to apply torque to the screw. However, some screws are connected to a conductive object so that the user can be hurt by electric current via the shank which generally is made by conductive material.

Another type of screwdriver includes an engaging recess defined in a distal end of the shank so that different types of bits can be engaged with the engaging recess. The engaging recess is worn out after a period of time of use and the bit cannot be well positioned in the engaging recess. The shank is usually made by conductive material which may shock the users by electric current.

The present invention intends to provide a screwdriver wherein the handle and the shank are made by non-conductive material such as Polyphenylene Sulfide (PPS), Polytetrafluoroethylene (PTFE) or Polyetheretherketones PEEK, and the function end is made by material of high hardness such as Polyoxymethylene (POM). The whole screwdriver is non-conductive while is strong and light.

### SUMMARY OF THE INVENTION

The present invention relates to a screwdriver that includes a handle with a shank integrally connected to the handle and a function end is connected to the other end of the shank. The handle and the shank are made by Polyphenylene Sulfide (PPS), Polytetrafluoroethylene (PTFE) or Polyetheretherketones (PEEK), the function end is made by Polyoxymethylene (POM).

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the screwdriver of the present invention;

FIG. 2A is a partial cross sectional view to show the screwdriver of the present invention;

FIG. 2B is an enlarged and partial cross sectional view to show the function end and the shank of the screwdriver of the present invention;

FIG. 3 shows a user holds the handle of the screw driver to access a screw;

FIG. 4A is a partial cross sectional view to show another embodiment of the function end of the screwdriver of the present invention, and

FIG. 4B is a partial cross sectional view to show yet another embodiment of the function end of the screwdriver of the present invention.

### DETAILED DESCRIPTION OF THE PREFERRED EMBODIMENT

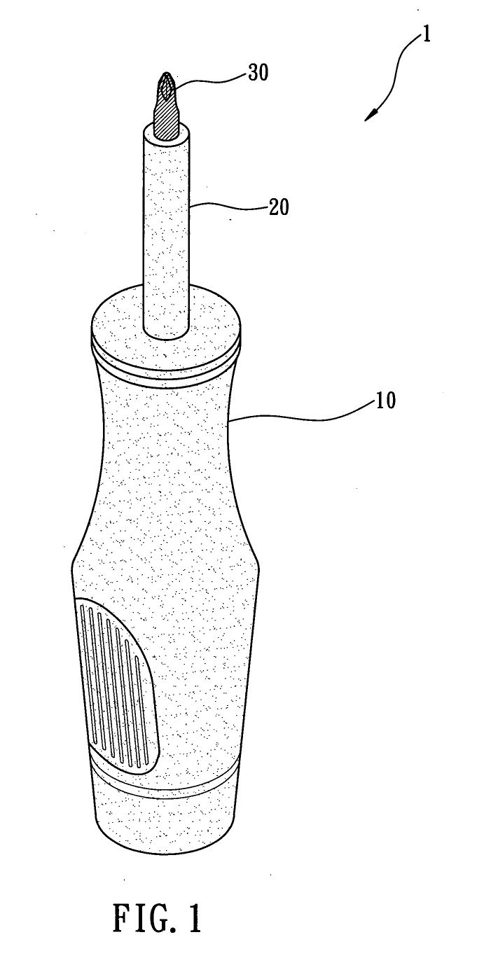

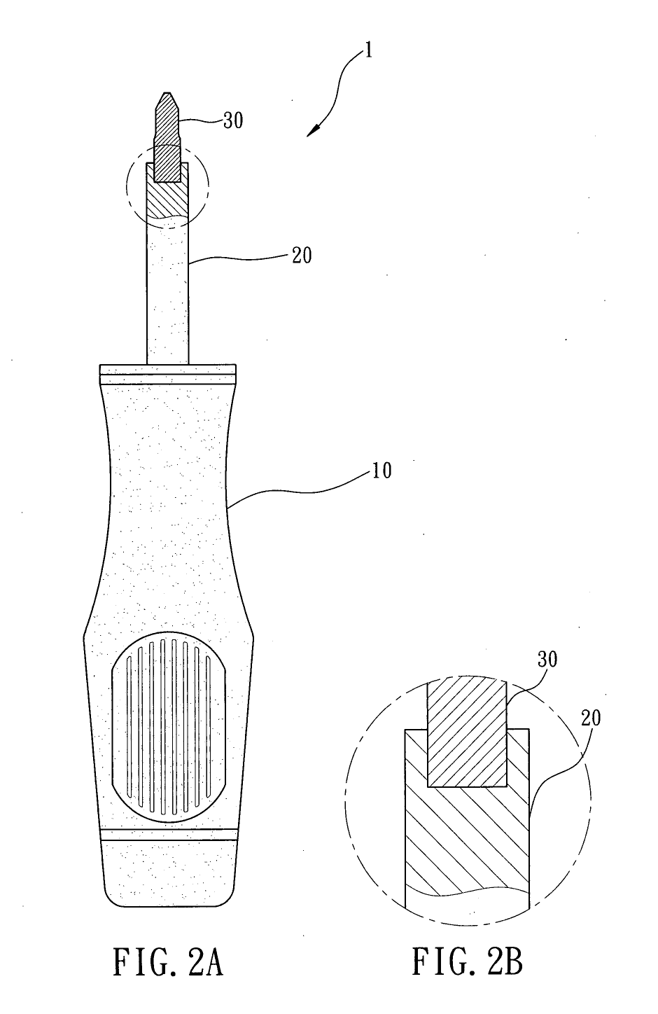

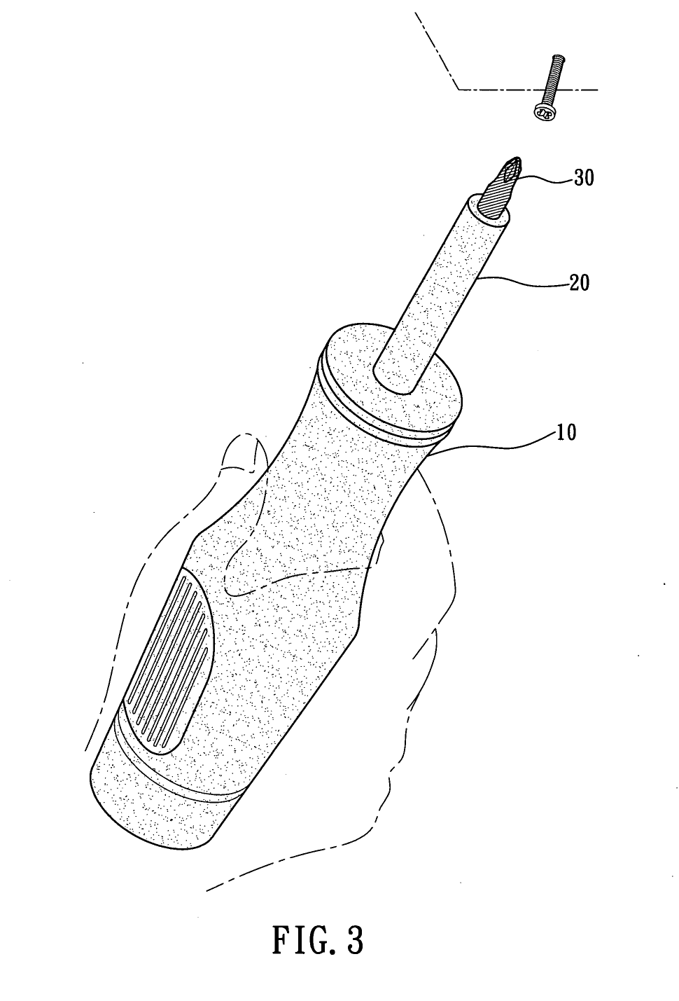

Referring to FIGS. 1, 2A, 2B and 3, the screwdriver 1 of the present invention comprises a handle 10, a shank 20 having one end integrally connected to the handle 10 and a function end 30 connected to the other end of the shank 20. The handle 10 and the shank 20 are made by non-conductive material such as Polyphenylene Sulfide (PPS), Polytetrafluoroethylene (PTFE) or (Polyetheretherketones) PEEK. The function end 30 is also made by non-conductive material such as Polyoxymethylene (POM).

The whole screwdriver 1 is non-conductive so that the user will not be hurt by electric current. The non-conductive material is light and the screwdriver can be easily manufactured by existed ways at low cost.

The screwdriver 1 allows the user to hold the handle 10 and the shank 20 to be in contact with the screw no matter what the screw is connected with a conductive object.

The handle 10 and the shank 20 can be made with different colors for convenience of identification needs.

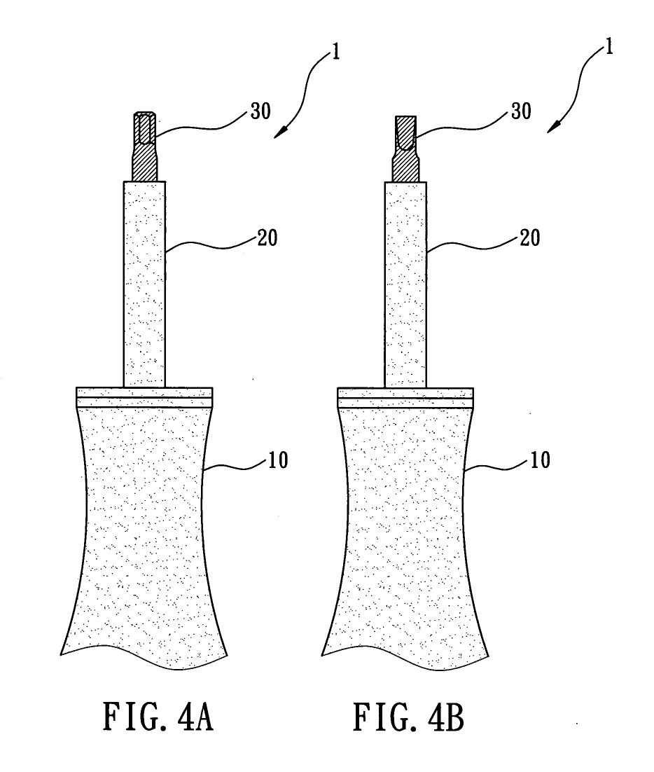

FIGS. 4A and 4B show that the function end 30 can be a polygonal end or a keystone tip. Any known type of function end can be used to the screwdriver 1 of the present invention.

While we have shown and described the embodiment in accordance with the present invention, it should be clear to those skilled in the art that further embodiments may be made without departing from the scope of the present invention.

What is claimed is:

1. A screwdriver comprising:
a handle;
a shank having one end integrally connected to the handle, and
a function end connected to the other end of the shank, the handle, the shank and the function end being made by non-conductive material.

2. The screwdriver as claimed in claim 1, wherein the handle and the shank are made by Polyphenylene Sulfide (PPS), Polytetrafluoroethylene (PTFE) or Polyetheretherketones (PEEK).

3. The screwdriver as claimed in claim 1, wherein the function end is made by Polyoxymethylene (POM).

4. The screwdriver as claimed in claim 1, wherein the handle and the shank are different colors.
